(19) United States
(12) Patent Application Publication
(10) Pub. No.: US 2009/0037401 A1
(43) Pub. Date: Feb. 5, 2009

(54) Information Retrieval and Ranking

(75) Inventors: Hang Li, Beijing (CN); Jun Xu, Beijing (CN)

Correspondence Address: LEE & HAYES PLLC, 601 W Riverside Avenue, Suite 1400, SPOKANE, WA, 99201, US

(73) Assignee: Microsoft Corporation, Redmond, WA (US)

(21) Appl. No.: 11/831,836

(22) Filed: Jul. 31, 2007

(51) Int. Cl. G06F 7/08; G06F 17/30

(52) U.S. Cl. 707/5; 707/E17.14

(57) ABSTRACT

A learning method is used to generate ranking models. The learning method can create a ranking function that assigns scores to documents and then ranks the documents using the scores. In this learning method, a training set along with performance measures are used to generate weak rankers which a used in the ranking model. During information retrieval, for a given query, the system may return a ranked list of documents in descending order of the relevance scores.

### BACKGROUND

With a large number of documents (including websites) being available in various databases and over the Internet, methods for efficiently retrieving information have recently gained a lot of importance. Ranking of relevant retrieved documents is one of the crucial elements in information retrieval. Ranking demonstrates the relevance of the document (e.g. website) to a given user query (e.g., website search). Currently, a number of different ranking models are in use for ranking of documents.

Learning to rank is a type of method generally used for ranking documents for document retrieval. Learning to rank algorithms automatically creates a ranking function that assigns scores to documents and then ranks the documents using the scores. In most of the existing methods, document pairs are used to retrieve these documents. The document pairs may use binary ranking, i.e. the document is either relevant or not relevant. These existing methods are based on an assumption that the document pairs from the same query are independently distributed. In addition, the numbers of documents pairs may vary from query to query resulting in creating models biased towards queries with more document pairs.

### SUMMARY

This summary is provided to introduce simplified concepts of uncovering logic flaws in graphical user interface, which is further described below in the Detailed Description. This summary is not intended to identify essential features of the claimed subject matter, nor is it intended for use in determining the scope of the claimed subject matter.

In an embodiment, training data or a training set are received along with performance measures and number of iterations as parameters. A weak ranker is created based on the performance measures for each iteration and is assigned a weight. From this a ranking model is generated.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates exemplary network architecture for implementing a method for learning to rank documents in document retrieval.

FIG. 2 illustrates a computing-based server device implementing the method for learning to rank documents in document retrieval.

FIG. 3 illustrates exemplary method(s) for implementing the methods for learning to rank documents in document retrieval.

FIG. 4 illustrates the learning curve of the methods for learning to rank documents in document retrieval.

FIG. 5 illustrates exemplary method(s) for implementing a ranking model to rank documents in document retrieval.

FIG. 6 illustrates an exemplary computing environment for implementing the methods for learning to rank documents in document retrieval.

### DETAILED DESCRIPTION

A description of systems and methods for implementing a method for learning to rank documents in document retrieval follow. Information retrieval or IR systems can be used to search for and retrieve documents over a large network like the World Wide Web. Examples of such systems include Microsoft® Live search, Google® search and America Online® search. An IR system can also be implemented in smaller networks or on personal computers. For example, institutions such as universities and public libraries can use IR systems to provide access to books, journals, and other documents. IR systems may include queries and objects. The queries are statements that are input to the IR systems by users. The objects are entities that store information in a database. During a search, a user's queries may be matched to objects such as documents, metadata, or surrogates of documents stored in the database. Furthermore, application of information retrieval can include document retrieval, collaborative filtering, key term extraction, and expert filtering.

The IR systems may generally include a database of documents, a classification methodology that may be employed to build an index, and a user interface. The IR systems may have two main tasks, one task to find relevant documents related to the user query, and a second task to rank these documents according to their relevance to the user query. In accordance to the relevance of a document to a given user query, relevance scores are assigned to the documents. A ranking model can be used to calculate and assign the relevance scores to the documents. Furthermore, the ranking model can rank the documents based on relevance scores and can display the list of retrieved documents as an index. A learning method can be used to generate ranking models. The learning method can automatically create a ranking function that assigns scores to documents and then ranks the documents using the scores. During information retrieval, for a given query, the system may return a ranked list of documents in descending order of the relevance scores.

The learning method constructs the ranking model for ranking the documents based on the minimization of a loss function. The loss function refers to the difference in rank between a pre-calculated relevance score and the relevance score provided by the learning method. The loss function may be defined based on performance measures used for information retrieval. There can be several measures of the performance of an information retrieval system. These measures may rely on a collection of documents and a query for which the relevance of the documents is known. These measures may also be known as performance measures and include, for example, Mean Average Precision (MAP), fall-out, Normalized Discounted Cumulative Gain (NDCG), etc.

The learning method uses a number of queries and their corresponding retrieved documents as training data to generate the ranking model. In addition, pre-calculated relevance scores of the retrieved documents can be provided to the learning method. The pre-calculated relevance scores may be generated, for example, by assignment of scores by people, or by other known techniques of ranking. The learning method can use the pre-calculated relevance scores to modulate the performance measures and to generate weak rankers. Weak rankers return ranks or relevance scores for documents from a list of documents. The method may then utilize a linear combination of these weak rankers to generate the ranking model. In learning, the method repeats the process of re-weighing the training data, creating a weak ranker, and calculating a weight for the ranker, to generate the ranking model.

Implementations of the ranking model may include but are not limited to retrieving and ranking information/documents stored in a computer system, such as in the World Wide Web, inside a corporate or proprietary network, or in a personal computer (PC), or documents available over the Internet.

### Exemplary Ranking System

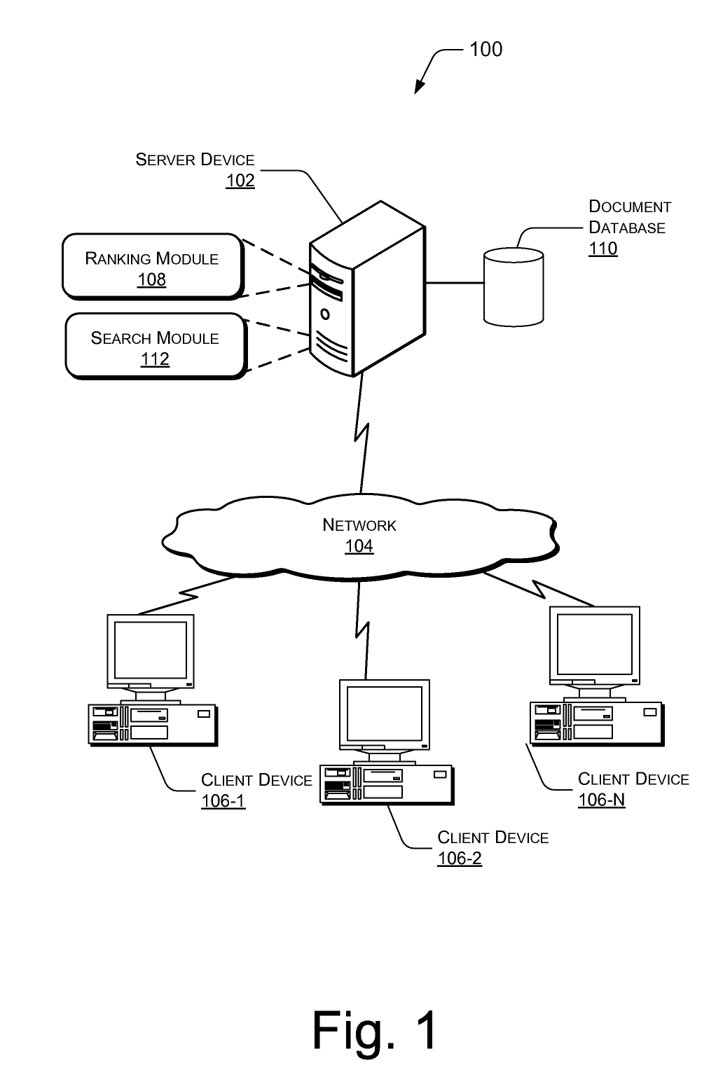

FIG. 1 shows an exemplary system 100 for ranking of documents retrieved for a given user query. To this end, the system 100 includes a server computing device 102 communicating through a network 104 with one or more client computing devices 106(1)-(N). In one implementation, the server computing device 102 can be a web search engine such as Microsoft® live search engine, Google® search engine, America Online® search engine, etc. The server computing device 102 may include a classification and/or ranking module 108, a database of documents/information 110, and a search module 112.

The system 100 can include any number of the client computing devices 106(1)-(N). For example, in one implementation, the system 100 can be the World Wide Web, including numerous PCs, servers, and other computing devices spread throughout the world. Alternatively, in another possible implementation, the system 100 can include a LAN/WAN with a limited number of PCs.

In this implementation, the database of documents/information 110 present in or associated with the server computing device 102 can be accessible by client computing devices 106(1)-(N) through the network 104 using one or more protocols, for example, a transmission control protocol running over Internet protocol (TCP/IP).

The client computing devices 106(1)-(N) can be coupled to each other or to the server computing device 102 in various combinations through a wired and/or wireless network, including a LAN, WAN, or any other networking technology known in the art.

The server-computing device 102 can have a database of documents/information 110 as an inherent part of the server computing device 102 or the database of documents/information 110 may be present over a number of external sources spread over the entire network. For example, the server computing device 102 can be the USPTO search engine, the IEEE search engine and so on, that maintain their own private database of documents/information 110. Alternatively, the server computing device 102 can be a web search engine such as, for example, the Microsoft® live search engine, the Google® search engine, the America Online® Search, and so on that do not maintain their own database of documents/information 110 but use external sources to retrieve information requested by clients or users.

The server computing device 102 includes the ranking module 108 to implement the learning method that generates a ranking model. The search module 112, also present in the server computing device 102, utilizes the ranking model to classify and rank the retrieved documents into an index based on their relevance to the client query. Usually, the quality of ranking of the documents can be used to judge the performance of a search engine, i.e. the better the ranking of documents in accordance with the user query, the better the search engine is perceived to be. Therefore, it is desirable to index the retrieved documents in accordance to their relevance to the query based on an efficient ranking model.

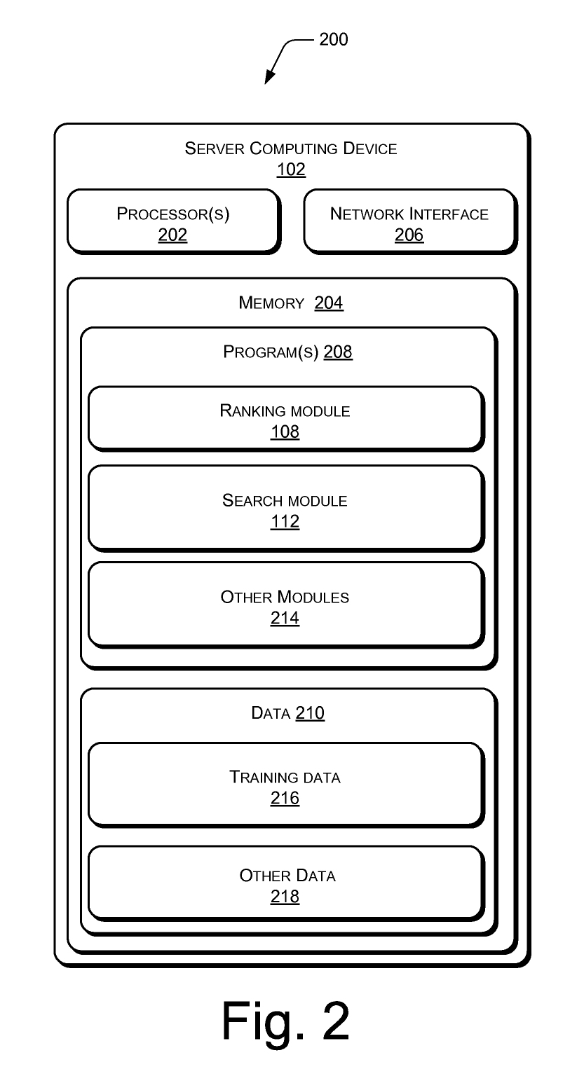

FIG. 2 illustrates an exemplary server computing device 102 on which, the learning method for document retrieval can be implemented. It is to be appreciated, that implementation of the learning method may also be performed on standalone computing devices. In this example, the server computing device 102 may include one or more processor(s) 202, a memory 204, and one or more network interfaces 206. The processor(s) 202 can be a single processing unit or a number of units, all of which could include multiple computing units. The processor(s) 202 may be implemented as one or more microprocessors, microcomputers, microcontrollers, digital signal processors, central processing units, state machines, logic circuitries, and/or any devices that manipulate signals based on operational instructions. Among other capabilities, the processor(s) 202 can be configured to fetch and execute computer-readable instructions stored in the memory 204.

The memory 204 can include any computer-readable medium known in the art including, for example, volatile memory (e.g. RAM) and/or non-volatile memory (e.g., flash, etc.). The memory 204 stores program instructions that can be executed by the processor(s) 202.

The network interface(s) 206 facilitates communication between the server computing device 102 and the client computing devices 106(1)-(N). Furthermore, the network interface(s) 206 may include one or more ports for connecting a number of client-computing devices 106(1)-(N) to the server computing devices 102. The network interface(s) 206 can facilitate communications within a wide variety of networks and protocol types, including wired networks (e.g. LAN, cable, etc.) and wireless networks (e.g. WLAN, cellular, satellite, etc.). In one implementation, the server computing device 102 can receive input query from a user or client via the ports connected through the network interface(s) 206 and the server computing device 102 can send back the retrieved relevant document list back to the client computing device via the network interface(s) 206.

Memory 204 includes program(s) 208 and program data (data) 210. Program(s) 208 include for example, the ranking module 108, the search module 112 and other module(s) 214. The data 210 includes training data 216 and other data 218. The other data 218 stores various data that may be generated or required during the functioning of the server computing device 102.

The ranking module 108 implements a learning method for generating a ranking model. In an implementation, the learning method constructs weak rankers based on weighed training data 216 and linearly combines the weak rankers to create the ranking model. Weak rankers are generated by the learning method based on calculations carried out on the training data 216 using performance measures as parameters. For this, weights are assigned to the training data 216 and the training data 216 is adapted iteratively using these weights in accordance with a pre-defined output. The pre-defined output may correspond to, for example, a desired performance measure level. As the weights assigned to the training data 216 can vary during the process, it may be referred to as weighed training data

The training data 216 includes data such as, for example, a set of arbitrary query elements, retrieved documents corresponding to the query elements, and relevance levels given by users (i.e., user defined) to these retrieved documents. The ranking module 108 automatically creates a ranking function that assigns scores to documents and then ranks the documents by using the scores.

The ranking module 108 receives the training data 216 as the input along with performance measures and number of iterations as parameters. Initially all the query elements may be given equal weights. After every round of iteration, a ranking function or weak ranker may generated. The query elements that do not generate enough retrieved documents as compared to the rest of the query elements may be given a higher weight compared to the others in the next round of iteration, so that in the next iteration that query element in particular can generate more retrieved documents. The training data may be re-weighed during the rounds of iterations, and at every round of iteration, a weak ranker or ranking function may be generated.

Finally, after the completion of all the iterations, the ranking module 108 linearly combines the weak rankers and creates a ranking model. The ranking model created is thus directly dependant on the performance measures. Any performance measure can be used as a parameter to reduce the loss function, for example MAP, NDCG, etc.

The search module 112 utilizes the ranking model obtained from the ranking module 108. The search module 112 may use client (i.e., client device) queries as input, searches for relevant documents and utilizes the ranking model to rank retrieved documents in accordance to their relevance to the input user query. The retrieved relevant documents may be indexed and a brief description about the retrieved documents can be added to the index, for example, an abstract about the document or a brief overview. This provides a more user-friendly index that makes it easy to read the retrieved documents.

### Exemplary Ranking Method

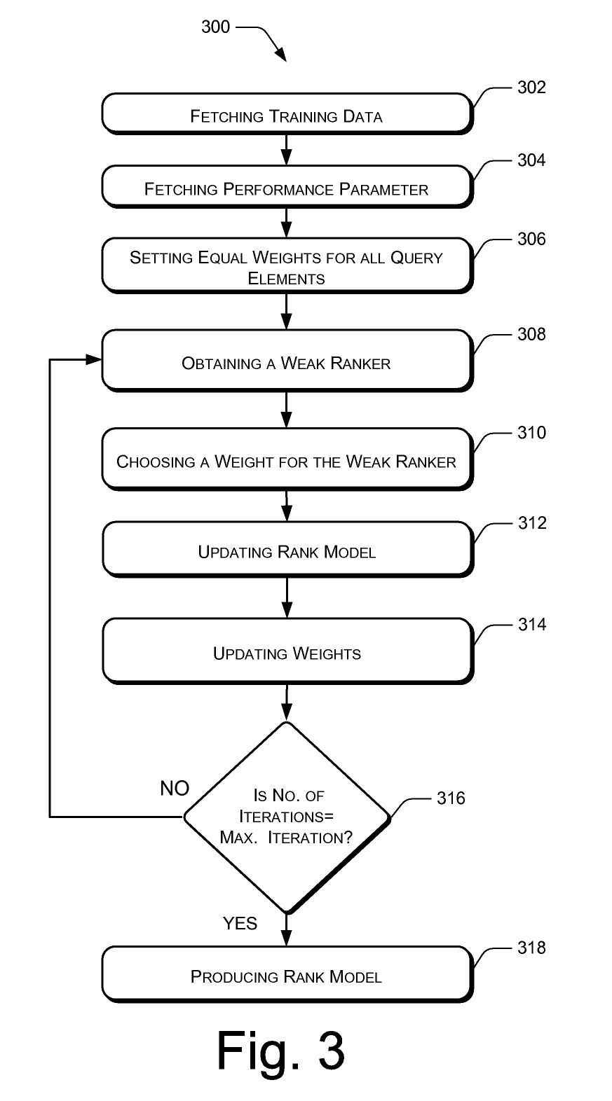

FIG. 3 illustrates an exemplary learning method 300 that can be implemented by the ranking module 108 for generating the ranking model. The exemplary method 300 further illustrates generating the ranking model based on training data and related performance measures, which are used as the parameters for the learning method. The ranking model generated using this method can directly optimize the performance measures and can minimize a loss function. In one implementation, the loss function can be an exponential loss function.

The order in which the method is described is not intended to be construed as a limitation, and any number of the described method blocks can be combined in any order to implement the method, or alternate method. Additionally, individual blocks may be deleted from the method without departing from the spirit and scope of the subject matter described herein. Furthermore, the method can be implemented in any suitable hardware, software, firmware, or a combination thereof, without departing from the scope of the invention.

At block 302, a training set is fetched by the ranking module 108, from the training data 216 present in the data 210. In an implementation, the training data 216 may include a set of query elements, a set of retrieved documents corresponding to each of the query elements, and the pre-calculated relevance scores for the retrieved documents.

The set of queries in the training set are represented as Q={q₁, q₂, q₃, . . . , qₘ}. Each query qᵢ is associated with a list of retrieved documents dᵢ={dᵢ₁,dᵢ₂,dᵢ₃, . . . ,d_{i,n(q)}} and a list of relevance scores yᵢ={yᵢ₁, yᵢ₂, yᵢ₃, . . . , y_{i,n(q)}}, where n(qᵢ) denotes sizes of the lists dᵢ and yᵢ, dᵢⱼ denotes the j^{th} document in dᵢ, and yᵢⱼ denotes the relevance score of document dᵢⱼ. A feature vector \vec{x}ᵢⱼ=ψ(qᵢ,dᵢⱼ)εχ is created from each query document pair (qᵢ, dᵢⱼ), i=1, 2, 3, . . . , m; j=1, 2, 3, . . . , n(qᵢ). Thus, the training set can be represented as S={(qᵢ,dᵢ,yᵢ)}ᵢ₌₁^{m}. The training set is the input to the ranking module 108 that implements a learning method to generate the ranking model.

At block 304, the ranking module 108 fetches one or more parameters from the data memory 210. The parameters include performance measures such as, for example, Mean Average Precision (MAP), Normalized Discounted Cumulative Gain (NDCG), Mean Reciprocal Rank (MRR), and Winner Takes All (WTA) and so on. An objective of the ranking module 108 is to create a ranking function ƒ:χ [symbol] , such that for each query, the elements in its corresponding document list can be assigned relevance scores using the ranking function and can then be ranked according to the scores. In one implementation, a permutation of integers π(qᵢ, dᵢ, ƒ) is created for query qᵢ, the corresponding list of documents dᵢ, and the ranking function ƒ. In one embodiment the performance measures are represented generally using the following equation:

E(π(qᵢ,dᵢ,ƒ),yᵢ)ε[−1,+1]

The first argument of E is the permutation π created using the ranking functions on dᵢ. The second argument is the list of relevance scores yᵢ given by humans (i.e. user defined relevance scores). E measures the agreement between π and yᵢ.

Mean Average Precision for a given query qᵢ, the corresponding list of ranks yᵢ, and a permutation πᵢ on dᵢ is defined as:

$${AvgP}_{i} = \frac{{\sum }_{j = 1}^{n ( {q}_{i} )} {P}_{i} ( j ) \cdot {y}_{ij}}{{\sum }_{j = 1}^{n ( {q}_{i} )} {y}_{ij}}$$

Where yᵢⱼ takes on 1 and 0 as values, representing being relevant or irrelevant and Pᵢ₍ⱼ₎ is defined as precision at the position of dᵢⱼ.

$${P}_{i} ( j ) = \frac{{\sum }_{k \text{:} {π}_{i} ( k ) \leq {π}_{i} ( j )} {y}_{ik}}{{π}_{i} ( j )}$$

Where πᵢ₍ⱼ₎ denotes the position of dᵢⱼ.

Normalized Discounted Cumulative Gain for a given query qᵢ, the list of relevance scores yᵢ, and a permutation pᵢ on dᵢ at position m for qᵢ is defined as:

$${N}_{i} = {n}_{i} \cdot {\sum }_{j \text{:} {π}_{i} ( j ) \leq m} \frac{{2}^{{y}_{ij}} - 1}{log ( 1 + {π}_{i} ( j ) )}$$

Where yᵢⱼ takes on ranks as values and nᵢ is normalization constant. nᵢ is chosen so that a perfect ranking πᵢ's NDGC score at position m is 1.

Any of the above mentioned performance measures could be used as the parameters for the learning method. The method described here is thus directly based on these performance measures and not just loosely based or correlated to the performance measure like in the existing methods.

At block 306, initially, before any iteration is carried out, equal weights are assigned to all the query elements. For each round, the learning method maintains a distribution of weights over the queries in the training data. In one implementation, the distribution of weights at round t can be denoted as Pₜ, and the weight on the i^{th} training query qᵢ at round t can be denoted as Pₜ₍ᵢ₎. Therefore, the weight set initially to all the query elements is P₀₍ᵢ₎=1/m.

At block 308, the learning method generates a weak ranker. The weak ranker hₜ(\vec{x}) is constructed based on training data with weight distribution Pₜ. The goodness of a weak ranker is measured by the performance measure E weighted by Pₜ.

$${\sum }_{i = 1}^{m} {P}_{t} ( i ) E ( π ( {q}_{i} , {d}_{i} , {h}_{t} ) , {y}_{i} )$$

Several methods for weak ranker construction can be considered. For example, in one implementation, a weak ranker can be created by using a subset of queries together with their document list and relevance score list sampled according to the distribution Pₜ. The feature that has the most optimal weighted performance among all of the features can be chosen as a weak ranker:

$${max}_{k} {\sum }_{i = 1}^{m} {P}_{t} ( i ) E ( π ( {q}_{i} , {d}_{i} , {x}_{k} ) , {y}_{i} )$$

When weak rankers are created in this way, the learning process repeatedly selects features and linearly combines the selected features. Features that are not selected in the training phase can be assigned a weight of zero.

At block 310, the learning method chooses a weight αₜ>0 for the weak ranker generated at block 308. The weight αₜ measures the importance of the weak ranker obtained in the previous block 308. In one implementation, the equation that defines the weak ranker weight is:

$${α}_{t} = \frac{1}{2} \cdot ln \frac{{\sum }_{i = 1}^{m} {P}_{t} ( i ) \{ 1 + E ( π ( {q}_{i} , {d}_{i} , {h}_{t} ) , {y}_{i} ) \}}{{\sum }_{i = 1}^{m} {P}_{t} ( i ) \{ 1 - E ( π ( {q}_{i} , {d}_{i} , {h}_{t} ) , {y}_{i} ) \}}$$

At block 312, the ranking model obtained so far is updated. After each round of iteration, the ranking model is updated by linearly combining the weak rankers until that stage. The ranking model is denoted by ƒₜ, where t is number of weak rankers.

$${f}_{t} ( {x}^{->} ) = {\sum }_{k = 1}^{t} {α}_{k} {h}_{k} ( {x}^{->} )$$

At block 314, after each round of iteration, the distributed weights are updated. In one implementation, the learning method increases the weights of those queries that are not ranked well by ƒₜ, the ranking model created so far. As a result, the learning at the next round will be focused on the creation of weak rankers that can work on the ranking of the queries that did not produce good ranking for their corresponding relevant documents. The updated distribution weights Pₜ are defined by:

$${P}_{t + 1} ( i ) = \frac{exp \{ - E ( π ( {q}_{i} , {d}_{i} , {f}_{t} ) , {y}_{i} ) \}}{{\sum }_{j = 1}^{m} exp \{ - E ( π ( {q}_{j} , {d}_{j} , {f}_{t} ) , {y}_{j} ) \}}$$

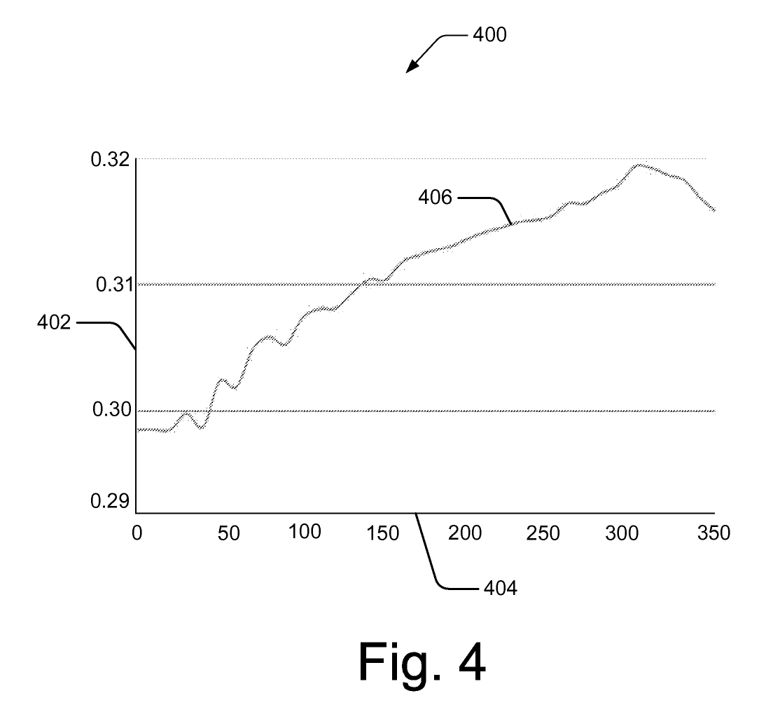

At block 316, it is determined whether any more iterations have to be carried out. The iterative method can be carried out until the performance measure keeps improving and reaches its peak value. FIG. 4 illustrates the number of iterations to achieve the best performance measure value in one implementation, and will be discussed in detail later. The number of iterations that correspond to the peak value of the performance measure is also known as the maximum number of iterations.

If the number of iterations t, is equal to the maximum number of iterations T (i.e., following the YES path from block 316), the method can be allowed to proceed and the final ranking model can be created (i.e., block 318). Alternatively, if the number of iterations t is not equal to the maximum number of iterations T (i.e., following the NO path from block 316) the process will repeat itself again from block 308 onwards.

At block 318, the final ranking model is generated and is stored as output for further processing and use by the search module 112. In an implementation, the ranking model output is defined by:

ƒ(\vec{x})=ƒ_{T}(\vec{x})

FIG. 4 illustrates the learning curve 400 as followed by the ranking module 108 in one implementation. 402 represents the number of rounds or iterations, while 404 represents the performance measure. In one implementation, the performance measure used as a parameter can be the Mean Average Precision (MAP). In the figure 400, the performance measure, MAP keeps improving up until approximately 300 iterations as shown by the curve 406, after that the performance measure drops. Therefore, as can be seen from FIG. 4, in this implementation, 300 iterations would be ideal while using Mean Average Precision as a parameter.

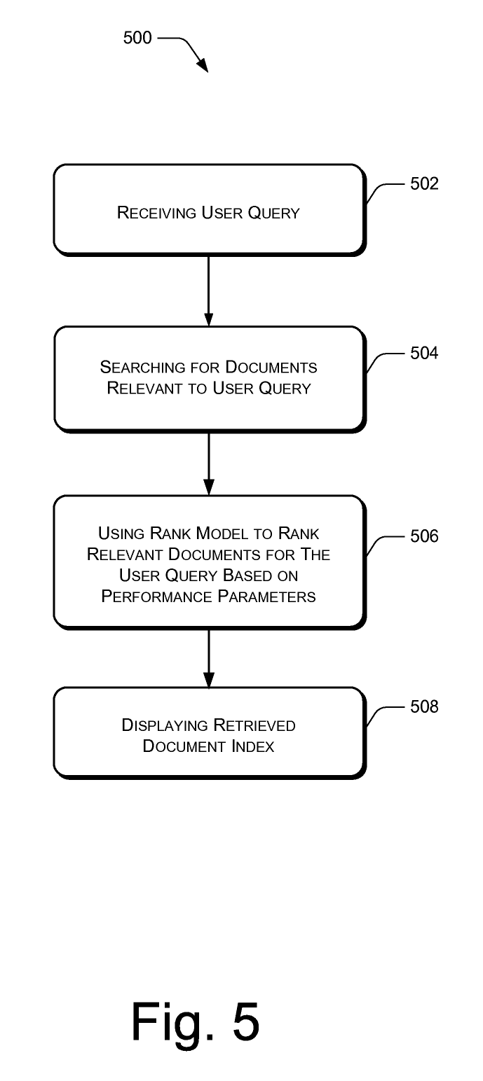

FIG. 5 illustrates an exemplary method 500 that can be implemented by the search module 112 to retrieve documents for a given user query. The exemplary method 500 further illustrates ranking the documents based on the ranking model generated by the method described in the previous figure 300. Applications can include information retrieval such as document retrieval, collaborative filtering, key term extraction and expert finding. Furthermore, applications can also include natural language processing such as machine translation, paraphrasing, and sentiment analysis.

The order in which the method is described is not intended to be construed as a limitation, and any number of the described method blocks can be combined in any order to implement the method, or alternate method. Additionally, individual blocks may be deleted from the method without departing from the spirit and scope of the subject matter described herein. Furthermore, the method can be implemented in any suitable hardware, software, firmware, or a combination thereof, without departing from the scope of the invention.

At block 502, the user query is input into the search module 112 of the server computing device 102. In one implementation, the query can be input from the client computing devices 106(1)-(N) in the case of a network. Alternately, the query can be input from the personal computer itself in the case where the search engine is present in the same computing device.

At block 504, the search module retrieves documents that are relevant to the user query. These documents are retrieved from the database of documents/information 110 in the case of small local networks. Alternately, these documents are retrieved from distributed locations over the entire network in the case of web engines.

At block 506, the ranking model generated by the ranking module 108 can be utilized to rank the retrieved documents in accordance with their relevance to the user query. In one embodiment, the ranking model used is directly based on the performance measures. The retrieved documents are ranked according to their relevance to the query elements. The ranking model attempts to minimize the loss function and optimize the performance measure of the ranking model. In one implementation, the loss function can be exponential loss function and the means to minimize this exponential loss function are described in detail below.

At block 508, the retrieved ranked documents are arranged in an index. In one implementation, some information can be added to the document list about each document, for example, an abstract of the document, the key ideas contained in the document etc. The index is sent over the network 104 to be displayed on the user or client computing device 106(1)-(N) in a user-friendly manner.

### Minimization of Loss Function

The learning method implemented by the ranking module 108 can optimize a loss function based on queries as well, instead of document pairs as used in the existing methods. Furthermore, the loss function may be defined based on general information retrieval or IR performance measures. The measures can be Mean Average Precision (MAP), Normalized Distributed Cumulative Gain (NDCG), WTA, MRR, or any other measures, which fall within the range [−1, +1].

The ranking accuracy may be maximized in terms of a performance measure on the training data, as represented in the following equation:

$${max}_{f ∈ ℱ} {\sum }_{i = 1}^{m} E ( π ( {q}_{i} , {d}_{i} , f ) , {y}_{i} ) \qquad ( 1 )$$

where F is the set of all possible ranking functions. This is equivalent to minimizing the loss on the training data, as represented in the following equation:

$${min}_{f ∈ ℱ} {\sum }_{i = 1}^{m} ( 1 - E ( π ( {q}_{i} , {d}_{i} , {f}_{t} ) , {y}_{i} ) ) \qquad ( 2 )$$

It may be difficult to directly minimize the loss function, because the performance measure E is a non-continuous function and thus may be difficult to handle. Instead, an attempt is made to minimize an upper bound of the loss in equation (2).

$${min}_{f ∈ ℱ} {\sum }_{i = 1}^{m} exp \{ - E ( π ( {q}_{i} , {d}_{i} , f ) , {y}_{i} ) \} \qquad ( 3 )$$

Because e−x≧1−x holds for any xεR. A linear combination of weak rankers is considered as the ranking model:

$$f ( {x}^{->} ) = {\sum }_{t = 1}^{T} {α}_{t} {h}_{t} ( {x}^{->} ) \qquad ( 4 )$$

Then the minimization in equation (3) turns out to be:

$${min}_{{h}_{t} ∈ ℋ \cdot {α}_{t} ∈ {ℛ}^{+}} L ( {h}_{t} , {α}_{t} ) = {\sum }_{i = 1}^{m} exp \{ - E ( π ( {q}_{i} , {d}_{i} , {f}_{t - 1} + {α}_{t} {h}_{t} ) , {y}_{i} ) \} \qquad ( 5 )$$

Where H is the set of possible weak rankers, αₜ is a positive weight, and (ƒₜ₋₁+αₜhₜ)(\vec{x})=ƒₜ₋₁(\vec{x})+αₜhₜ(\vec{x}).

Several ways for computing coefficients αₜ and weak rankers hₜ may be considered. In one implementation, the approach of “forward stage-wise additive modeling” is taken to get the learning method described in the FIG. 3. A lower bound on the ranking accuracy can exist for this method on the training data, as presented below:

$$\frac{1}{m} {\sum }_{i = 1}^{m} E ( π ( {q}_{i} , {d}_{i} , {f}_{T} ) , {y}_{i} ) \geq 1 - {\prod }_{t = 1}^{T} {e}^{- {δ}^{t}} min \sqrt{1 - {ϕ ( t )}^{2}} , \\ Where$$

$$ϕ ( t ) = {\sum }_{i = 1}^{m} {P}_{t} ( i ) E ( π ( {q}_{i} , {d}_{i} , {h}_{t} ) , {y}_{i} ) , {δ}_{min}^{t} = {min}_{i = 1 , … , m} {δ}_{i}^{t} , \\ and$$

$${σ}_{i}^{t} = E ( π ( {q}_{i} , {d}_{i} , {f}_{t - 1} + {α}_{t} {h}_{t} ) , {y}_{i} ) - E ( π ( {q}_{i} , {d}_{i} , {f}_{t - 1} ) , {y}_{i} ) - {α}_{t} E ( π ( {q}_{i} , {d}_{i} , {h}_{t} ) , {y}_{i} ) , \\ for all$$

$$i = 1 , 2 , … , m$$

$$and$$

$$t = 1 , 2 , … , T$$

The theorem implies that the ranking accuracy in terms of the performance measures can be continuously improved using this method, as long as e^{-δ}^{ₘᵢₙ}^{^{t}}\sqrt{1−φ(t)²}<1 holds.

### Exemplary Computer Environment

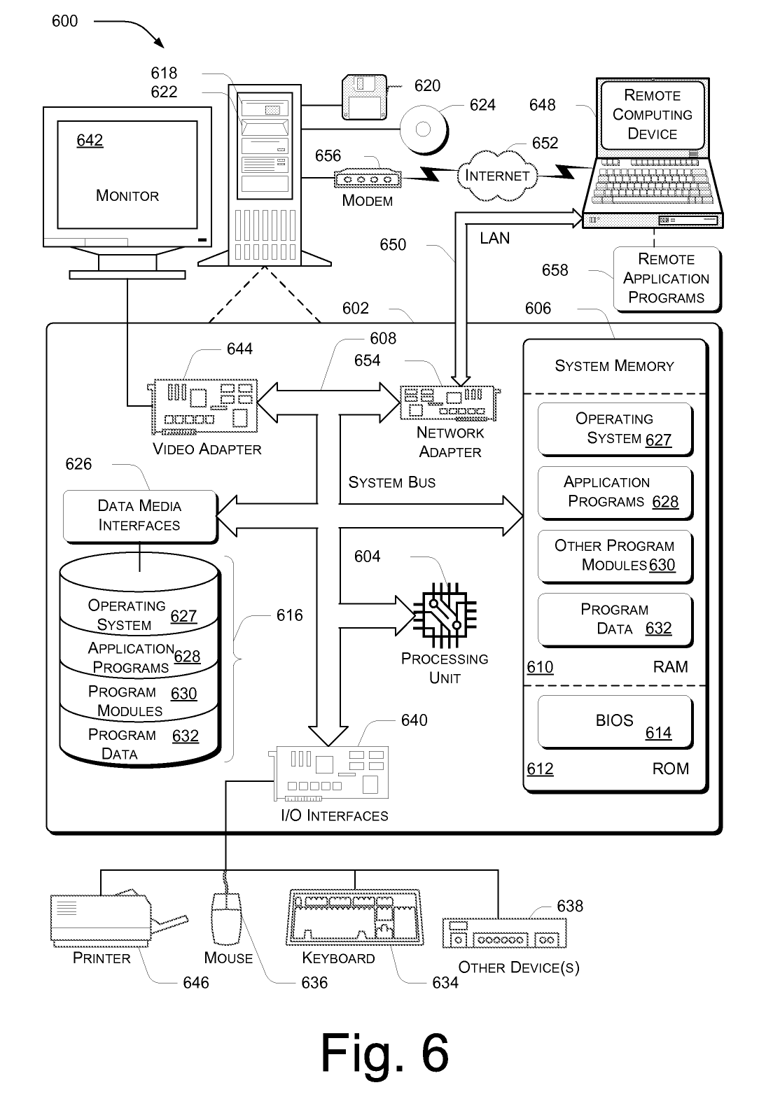

FIG. 6 illustrates an exemplary general computer environment 600, which can be used to implement the techniques described herein, and which may be representative, in whole or in part, of elements described herein. The computer environment 600 is only one example of a computing environment and is not intended to suggest any limitation as to the scope of use or functionality of the computer and network architectures. Neither should the computer environment 600 be interpreted as having any dependency or requirement relating to any one or combination of components illustrated in the example computer environment 600.

Computer environment 600 includes a general-purpose computing-based device in the form of a computer 602. Computer 602 can be, for example, a desktop computer, a handheld computer, a notebook or laptop computer, a server computer, a game console, and so on. The components of computer 602 can include, but are not limited to, one or more processors or processing units 604, a system memory 606, and a system bus 608 that couples various system components including the processor 604 to the system memory 606.

The system bus 608 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 602 typically includes a variety of computer readable media. Such media can be any available media that is accessible by computer 602 and includes both volatile and non-volatile media, removable and non-removable media.

The system memory 606 includes computer readable media in the form of volatile memory, such as random access memory (RAM) 610, and/or non-volatile memory, such as read only memory (ROM) 612. A basic input/output system (BIOS) 614, containing the basic routines that help to transfer information between elements within computer 602, such as during start-up, is stored in ROM 612 is illustrated. RAM 610 typically contains data and/or program modules that are immediately accessible to and/or presently operated on by the processing unit 604.

Computer 602 may also include other removable/non-removable, volatile/non-volatile computer storage media. By way of example, FIG. 6 illustrates a hard disk drive 616 for reading from and writing to a non-removable, non-volatile magnetic media (not shown). furthermore FIG. 6 illustrates a magnetic disk drive 618 for reading from and writing to a removable, non-volatile magnetic disk 620 (e.g., a “floppy disk”), additionally FIG. 6 illustrates an optical disk drive 622 for reading from and/or writing to a removable, non-volatile optical disk 624 such as a CD-ROM, DVD-ROM, or other optical media. The hard disk drive 616, magnetic disk drive 618, and optical disk drive 622 are each connected to the system bus 608 by one or more data media interfaces 626. Alternately, the hard disk drive 616, magnetic disk drive 618, and optical disk drive 622 can be connected to the system bus 608 by one or more interfaces (not shown).

The disk drives and their associated computer-readable media provide non-volatile storage of computer readable instructions, data structures, program modules, and other data for computer 602. Although the example illustrates a hard disk 616, a removable magnetic disk 620, and a removable optical disk 624, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 616, magnetic disk 620, optical disk 624, ROM 612, and/or RAM 610, including by way of example, an operating system 626, one or more application programs 628, other program modules 630, and program data 632. Each of such operating system 626, one or more application programs 628, other program modules 630, and program data 632 (or some combination thereof) may implement all or part of the resident components that support the distributed file system.

A user can enter commands and information into computer 602 via input devices such as a keyboard 634 and a pointing device 636 (e.g., a “mouse”). Other input devices 638 (not shown specifically) may include a microphone, joystick, game pad, satellite dish, serial port, scanner, and/or the like. These and other input devices are connected to the processing unit 1504 via input/output interfaces 640 that are coupled to the system bus 608, but may be connected by other interface and bus structures, such as a parallel port, game port, or a universal serial bus (USB).

A monitor 642 or other type of display device can also be connected to the system bus 608 via an interface, such as a video adapter 644. In addition to the monitor 642, other output peripheral devices can include components such as speakers (not shown) and a printer 646, which can be connected to computer 602 via the input/output interfaces 640.

Computer 602 can operate in a networked environment using logical connections to one or more remote computers, such as a remote computing-based device 648. By way of example, the remote computing-based device 648 can be a personal computer, portable computer, a server, a router, a network computer, a peer device or other common network node, and the like. The remote computing-based device 648 is illustrated as a portable computer that can include many or all of the elements and features described herein relative to computer 602.

Logical connections between computer 602 and the remote computer 648 are depicted as a local area network (LAN) 650 and a general wide area network (WAN) 652. Such networking environments are commonplace in offices, enterprise-wide computer networks, intranets, and the Internet.

When implemented in a LAN networking environment, the computer 602 is connected to a local network 650 via a network interface or adapter 654. When implemented in a WAN networking environment, the computer 602 typically includes a modem 656 or other means for establishing communications over the wide network 652. The modem 656, which can be internal or external to computer 602, can be connected to the system bus 608 via the input/output interfaces 640 or other appropriate mechanisms. It is to be appreciated that the illustrated network connections are exemplary and that other means of establishing communication link(s) between the computers 602 and 648 can be employed.

In a networked environment, such as that illustrated with computing environment 600, program modules depicted relative to the computer 602, or portions thereof, may be stored in a remote memory storage device. By way of example, remote application programs 658 reside on a memory device of remote computer 648. For purposes of illustration, application programs and other executable program components such as the operating system are illustrated herein as discrete blocks, although it is recognized that such programs and components reside at various times in different storage components of the computing-based device 602, and are executed by the data processor(s) of the computer.

Various modules and techniques may be described herein in the general context of computer-executable instructions, such as program modules, executed by one or more computers or other devices. Generally, program modules include routines, programs, objects, components, data structures, etc. that performs particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Alternately, portions of the framework may be implemented in hardware or a combination of hardware, software, and/or firmware. For example, one or more application specific integrated circuits (ASICs) or programmable logic devices (PLDs) could be designed or programmed to implement one or more portions of the framework.

### CONCLUSION

Although embodiments for implementing the learning method to generate a ranking model have been described in language specific to structural features and/or methods, it is to be understood that the subject of the appended claims is not necessarily limited to the specific features or methods described. Rather, the specific features and methods are disclosed as exemplary implementations for providing the learning technique to generate the ranking model.

What is claimed is:

1. A method comprising:
fetching training data;
fetching one or more parameters that include performance measures as applied to the training data;
creating a weak ranker based on the performance parameters;
assigning a weight to the weak ranker; and
determining whether additional weak rankers are to be created.

2. The method of claim 1, wherein the fetching training data includes a set of query elements, a set of retrieved documents corresponding to each of the query elements, and pre-calculated relevance scores for the retrieved documents.

3. The method of claim 1, wherein the fetching one or more parameters includes performance parameters represented by a permutation created using a ranking function on a set of documents and user defined relevance scores.

4. The method of claim 1, wherein the creating the weak ranker is constructed with the training data having a weight distribution, and goodness of the weak ranker is measured by a performance measured weighted by the weight distribution.

5. The method of claim 1, wherein assigning a weak ranker weight is defined by the equation:
$${α}_{t} = \frac{1}{2} \cdot ln \frac{{\sum }_{i = 1}^{m} {P}_{t} ( i ) \{ 1 + E ( π ( {q}_{i} , {d}_{i} , {h}_{t} ) , {y}_{i} ) \}}{{\sum }_{i = 1}^{m} {P}_{t} ( i ) \{ 1 - E ( π ( {q}_{i} , {d}_{i} , {h}_{t} ) , {y}_{i} ) \}}$$

6. The method of claim 1 further updating a ranking model after each iteration of rounds of creating weak rankers.

7. The method of claim 6, wherein the updating is performed by linearly combining the weak rankers.

8. The method of claim 6, further comprising updating distribution weights of the training data after each iteration.

9. The method of claim 1 as applied to information retrieval, wherein the information retrieval is directed to one of the following: document retrieval, collaborative filtering, key term, extraction, or expert filtering.

10. The method of claim 1 as applied to natural language processing, wherein the natural language processing is directed to one of the following: machine translation, paraphrasing, and sentiment analysis.

11. A method used in a ranking model comprising:
inputting a user query;
retrieving documents relevant to the user query;
generating a ranking model to rank the documents, wherein the ranking model is based on performance measures and the ranking model minimizes loss function and the performance measures; and
arranging the ranked documents in an index.

12. The method of claim 11, wherein the inputting is from one or more client computing devices.

13. The method of claim 11, wherein the retrieving is from distributed locations in a network.

14. The method of claim 11, wherein the generating the ranking model includes an exponential loss function.

15. The method of claim 11, wherein the generating the ranking module includes a loss function based on information retrieval performance measures.

16. A computing device comprising:
a processor;
a memory configured to the processor; and
a ranking module in the memory, implementing a learning method to generate a ranking model, wherein the learning method constructs weak rankers based on weighted training data and combines the weak rankers to generate the ranking model.

17. The computing device of claim 16, wherein weighted training data is adapted iteratively using weights in accordance with a pre-defined output.

18. The computing device of claim 16, wherein the training data includes arbitrary query elements, retrieved documents corresponding to the query elements, and user defined relevance levels to the retrieved documents.

19. The computing device of claim 16, wherein the training data is re-weighted after weak rankers are constructed.

20. The computing device of claim 16 further comprising a search module in the memory, to receive queries as input.
